(19) United States
(12) Patent Application Publication
(10) Pub. No.: US 2026/0155590 A1
(43) Pub. Date: Jun. 4, 2026

(54) Removeable Lug Shoe Configuration for Circuit Breaker

(71) Applicant: ABB Schweiz AG, Baden (CH)

(72) Inventors: Jason Edward Harmon, Bristol, CT (US); Sreedevi Cataram, Beeramguda (IN); Nagesh Venkata Tumu, Unionville, CT (US); Mukesh Jain, Hyderabad (IN)

(73) Assignee: ABB Schweiz AG, Baden (CH)

(21) Appl. No.: 18/967,989

(22) Filed: Dec. 4, 2024

(51) Int. Cl. H01R 9/24; H01H 71/02; H02B 1/48

(52) U.S. Cl. CPC H01R 9/2416; H01H 71/02; H02B 1/48; H01H 2071/0292

(57) ABSTRACT

A device includes an electrical coupling point configured to receive an electrically conductive cable and convey current between the electrically conductive cable and a terminal extension. The terminal extension includes a conductive structure configured to electrically couple to the electrical coupling point at a first end of the terminal extension and a terminal of a circuit breaker at a second end of the terminal extension, and extend between the first end and the second end. The terminal extension is configured to extend away from the terminal at the second end to the electrical coupling of the lug at the first end outside of a housing of the circuit breaker.

### FIELD

The present disclosure relates to a lug shoe device and system. In particular, the present disclosure relates to a removeable lug shoe configuration for a circuit breaker.

### BACKGROUND

Circuit breakers can provide an interruptible circuit connection between load side cables (e.g., cables providing power within the circuit) and line side cables (e.g., cables providing power to the circuit). The circuit breaker can provide this connection by electrically connecting (e.g., crimping the contacts of the cable into a lug) the line side cables to the terminals of the circuit breaker at one end, and electrically connecting the load side cables to the terminals of the circuit breaker at the other end. In practice, multiple wiring configurations can be required, and whether the circuit breakers are housed in designated breaker boxes or not, the circuit breaker can be located such that there is limited space to provide a path for the load and/or line side cables. For example, some configurations can require both cables to come from the top of the circuit breaker (e.g., from above the circuit breaker), some can require both cables to come from the bottom of the circuit breaker (e.g., from below the circuit breaker), and other configurations can require line side cables to come from the top and load side cables to come from the bottom. Additionally, regulations can require that the on position of the circuit breaker has to be facing sideways (e.g., horizontally) or in the up direction (e.g. the switch pointing against a force of gravity and/or pointing away from a user depending on the orientation of the circuit breaker).

Accordingly, it may be desired to provide for both the line side cables and the load side cables to approach the circuit breaker from the same direction, rather than, for example, line side cables approaching the circuit breaker from a first end of the circuit breaker and the load side cables approaching the circuit breaker from a second end of the circuit breaker. However, the load side and/or line side cables can be too large, heavy, or stiff to bend the cables so that the cables can approach the circuit breaker from the same side but connect to the terminals on different ends of the circuit breaker. A typical approach to provide for the different cable direction configurations have included extensive mounting systems in their enclosed equipment using multiple lugs in different spots to accommodate every wiring configuration, which are often inflexible, expensive, and large in size.

### SUMMARY

In some examples, the present disclosure provides a device comprising an electrical coupling point configured to receive an electrically conductive cable and convey current between the electrically conductive cable and a terminal extension. The terminal extension comprises a conductive structure configured to electrically couple to the electrical coupling point at a first end of the terminal extension and a terminal of a circuit breaker at a second end of the terminal extension, and extend between the first end and the second end. The terminal extension is configured to extend away from the terminal at the second end to the electrical coupling of the lug at the first end outside of a housing of the circuit breaker.

Examples may include one of the following features, or any combination thereof. For instance, in some examples of the device, the electrical coupling point comprises a lug, and the device further comprises a housing comprising a first portion and a second portion. The first portion partially surrounds the lug and the second portion partially surrounds the terminal extension, and the first portion comprises an opening for receiving the electrically conductive cable in the lug.

In some variations, the housing comprises extensions configured to interface with corresponding grooves of the housing of the circuit breaker.

In some examples, the extensions comprise a length greater than their height, the extensions configured to interface with the corresponding grooves by sliding along a single plane into the corresponding grooves.

In some instance, the terminal extension is configured to extend perpendicularly to an axis of extension of the terminal.

In some variations, the terminal extension is configured to electrically couple to the terminal when positioned between the terminal and a surface affixed to the circuit breaker.

In some examples, the terminal extension extends away from an axis of extension of the terminal.

In some instances, the electrically conductive cable is a load side cable configured to travel a path around the circuit breaker to the terminal extension, and the terminal extension further extends to a point on the path of the electrically conductive cable.

In some variations, the electrically conductive cable is a line side cable configured to travel a path around the circuit breaker to the terminal extension, and the terminal extension further extends to a point on the path of the electrically conductive cable.

In some examples, the device further comprises a second electrical coupling point configured to receive a second electrically conductive cable and convey current between the second electrically conductive cable and a second terminal extension. The second terminal extension comprises a second conductive structure configured to extend from the second electrical coupling point to a second terminal of the circuit breaker, where an axis of extension of the second terminal is parallel to the axis of extension of the first terminal. The device further comprises a housing comprising a first portion partially surrounding the electrical coupling point, a second portion partially surrounding the second electrical coupling point, and a third portion partially surrounding the terminal extension and the second terminal extension. The second terminal extension is configured to extend away from the axis of extension of the second terminal in the opposite direction of the terminal extension.

In another aspect, a system is provided, the system comprising an electrically conductive cable; a circuit breaker, comprising a terminal configured to electrically couple to a terminal extension and a housing partially surrounding the terminal; and a terminal connecter comprising an electrical coupling point configured to receive an electrically conductive cable and convey current between the electrically conductive cable and the terminal extension. The terminal extension comprises a conductive structure configured to electrically couple to the electrical coupling point at a first end of the terminal extension and the terminal of the circuit breaker at a second end of the terminal extension, and extend between the first end and the second end. The terminal extension is configured to extend away from the terminal at the second end to the electrical coupling of the lug at the first end outside of a housing of the circuit breaker.

Examples may include one of the following features, or any combination thereof. For instance, in some examples of the system, the electrical coupling point comprises a lug, and the terminal connector further comprises a housing comprising a first portion and a second portion. The first portion partially surrounds the lug and the second portion partially surrounds the terminal extension. The first portion comprises an opening for receiving the electrically conductive cable in the lug.

In some variations, the housing comprises extensions configured to interface with corresponding grooves of the housing of the circuit breaker.

In some examples, the extensions comprise a length greater than their height, the extensions configured to interface with the corresponding grooves by sliding along a single plane into the corresponding grooves.

In some instances, the terminal extension is configured to extend perpendicularly to an axis of extension of the terminal.

In some variations, the terminal extension is configured to electrically couple to the terminal when positioned between the terminal and a surface affixed to the circuit breaker.

In some examples, the terminal extension extends away from an axis of extension of the terminal.

In some instances, the electrically conductive cable is a load side cable configured to travel a path around the circuit breaker to the terminal extension, and the terminal extension further extends to a point on the path of the electrically conductive cable.

In some variations, the electrically conductive cable is a line side cable configured to travel a path around the circuit breaker to the terminal extension, and the terminal extension further extends to a point on the path of the electrically conductive cable.

In some examples, the housing of the circuit breaker comprises an open side for receiving an electrically coupling for the terminal and a closed side on each side adjacent to the open side, and the terminal extension is further configured to extend from the terminal at the second end, across a closed side, and to the electrical coupling point at the first end.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an example circuit breaker box including an example terminal lug connector installed on the upward facing side of the circuit breaker according to one or more embodiments of the present disclosure;

FIG. 2 illustrates an example circuit breaker box including an example terminal lug connector installed on the downward facing side of the circuit breaker according to one or more embodiments of the present disclosure;

FIG. 3A illustrates an example terminal lug connector according to one or more embodiments of the present disclosure;

FIG. 3B illustrates an instillation of the terminal lug connector of FIG. 3A;

FIG. 3C illustrates a further view of the terminal lug connector of FIG. 3B;

FIG. 4A illustrates an example terminal lug connector according to one or more embodiments of the present disclosure;

FIG. 4B illustrates an instillation of the terminal lug connector of FIG. 4A;

FIG. 4C illustrates a further view of the terminal lug connector of FIG. 4B;

FIG. 5 illustrates an example terminal lug connector according to one or more embodiments of the present disclosure;

FIG. 6A illustrates an example terminal lug connector according to one or more embodiments of the present disclosure; and

FIG. 6B illustrates a further view of the terminal lug connector of FIG. 6A.

### DETAILED DESCRIPTION

Examples of the presented application will now be described more fully hereinafter with reference to the accompanying FIGS., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Devices and/or systems are herein disclosed that provide a terminal lug connector for a circuit breaker. Examples of these devices and/or systems can provide solutions to the problems in the prior art noted above that were identified by the inventors of the present application. For instance, the present application can provide terminal connectors that can be fit onto the terminals of one end of a circuit breaker (e.g., where the terminals are located inside a housing of the circuit breaker) and/or provide a terminal extension that can locate the lugs or another type of electrical connection point farther away from the terminals of the circuit breaker (e.g., outside of the housing of the circuit breaker) that allows both cables to approach the circuit breaker from the same direction. As a result, bending cables or installing complex arrangements of lugs and/or electrical connections can be unnecessary. For example, the lugs can terminate directly to the side of the breaker from the terminal, thereby adding no extended length to the breaker to accommodate any of the configurations. Moreover, the lug shoes can be removeable and/or interchangeable from the line side to the load side, further improving the flexibility of the lug shoe implementations and/or increasing the number of available wiring configurations while decreasing the spatial demands of the circuit breaker and/or cable system.

Embodiments of the present application can utilize multiple lug connection shoe (e.g., terminal lug connector) configurations. For example, lug connection shoes can be used on the line and/or load side of a circuit breaker, and/or multiple configurations of lug shoes can be used on the line and/or load side of the circuit breaker terminals. In some configurations, lug shoes are provided on each circuit breaker terminal of the line or load side, for example for use in bolt-on equipment applications. In other configurations, lug connection shoes can be provided on the line side and/or the load side, for example when a cable is provided in from top of the circuit breaker and out from bottom. In still other configurations, a lug connection shoe allows the lug connection shoes to reside along the side (e.g., the same side or different sides) of the circuit breaker. This configuration can allow for both incoming and/or outgoing wires to be brought in from the same side (e.g., allowing wires to be inserted from the top (line) or bottom (load) sides without requiring the wires to bend and without adding any length to the breaker), as is often desirable in single-breaker enclosed applications. One or more of these configurations of the lug connection shoes can be customer removeable and/or interchangeable. Additionally, and/or alternatively, the lug connection shoes can be removeable to accommodate bolt on connections, and/or one or more configurations can allow for lug connection shoe positioning on the line or load terminals in line with the breaker. Additionally, the lug connection shoes can be switched to allow the breaker to be mounted in the vertical position with the on position up as per regulations (e.g., standard UL 489).

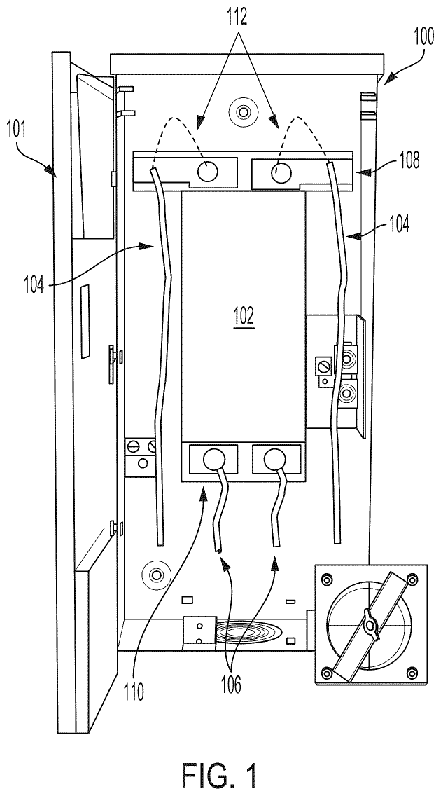

For example, FIG. 1 depicts a circuit breaker box 100 which can be mounted onto any structure (e.g., plywood, basement walls, steel beams, power line post). The circuit breaker box 100 includes a circuit breaker 102 mounted to a platform (e.g., the wall and/or plate) of the circuit breaker box 100, and door 101 can close over the circuit breaker 102 to enclose the circuit breaker 102. In the example of FIG. 1, there can be multiple rules for how the circuit breaker 102 must be positioned in the circuit breaker box 100. For instance, a handle position of the circuit breaker 102 may be required to be positioned upwards (e.g., vertically opposed to a gravitational pull), or sideways (e.g., horizontal relative to a gravitational pull). While allowing for a vertical positioning, the conductive wire cables (e.g., line side cables 104 and load side cables 106) enter the circuit breaker box 100 from the same side, the bottom, of the circuit breaker box 100. The line side cables 104 enter from the bottom of the circuit breaker box 100 and extend up to the lug connection shoes 108 (e.g., terminal lug connectors), extending up alongside the circuit breaker 102. Accordingly, line side cables 104 travel a path through the circuit breaker box 100 that travels around the circuit breaker 102 to the lug connection shoes 108. The lug connection shoes 108 are electrically connected to the terminals of the circuit breaker 102, extend outside of a housing of the circuit breaker 102, and receive the line side cables 104 at a point of extension of the lug connection shoes 108. In this way, the lug connection shoes 108 extend out to a point on the path of the line side cables 104. Without the lug connection shoes 108 extending out and/or intercepting a path of the line side cables 104, the line side cables 104 would need to travel path 112 in order to electrically connect to the terminals of the circuit breaker 102. However, this often is not possible (e.g., the conductive wire cables are too stiff, large, heavy, or bound by the dimensions of the circuit breaker box 100), and the lug connection shoes 108 can thereby resolve this problem (e.g., by extending out to the path of the line side cables 104). Lug connection shoes 110 can be provided on the bottom of the circuit breaker 102, where lug connection shoes 110 are in-line with the terminals of the circuit breaker 102 and receive the load side cables 106. The lug connection shoes 110 can be provided in-line to provide more space for a path of travel of the lines side cables 104. However, lug connection shoes 110 can also extend outside of the housing of the circuit breaker 102 as desired. Moreover, the line side cables 104 and/or load side cables 106 can be switched (e.g., electrically connected to the top or bottom of the circuit breaker) as needed for various applications.

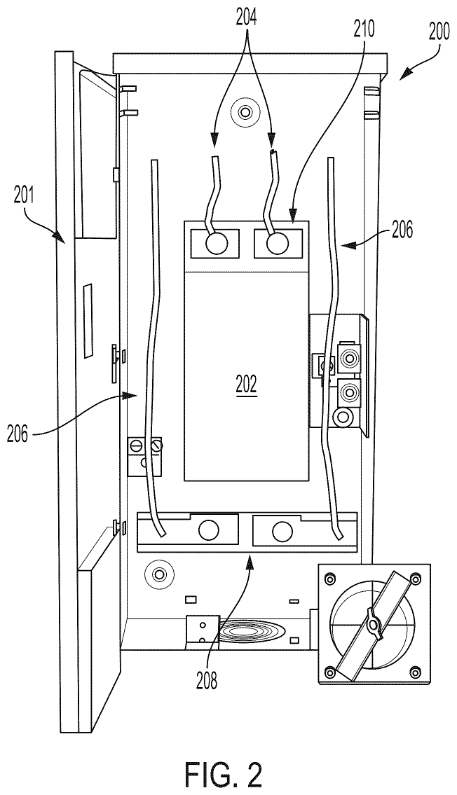

FIG. 2 depicts a circuit breaker box 200 according to an embodiment of the present application where the conductive wire cables both enter from the top of the circuit breaker box 200. Similar to circuit breaker box 100, the circuit breaker 202 can be fixed to the circuit breaker box 200 and door 201 can close over the circuit breaker 202 to enclose the circuit breaker 202. The conductive wire cables (e.g., line side cables 204 and/or load side cables 206) can both enter from the top of the circuit breaker box 200. The lug connection shoes 210 can be provided in-line with the circuit breaker 202 terminals and receive the line side cables 204. The lug connection shoes 208 can extend from the circuit breaker 202 terminals outside of a housing of the circuit breaker 202 to intercept a path of travel of the load side cables 206. The lug connection shoes 208 can receive the load side cables 206 via an electrical coupling point (e.g., a lug) at a point of extension along the lug connection shoe 208, similar to lug connection shoes 108.

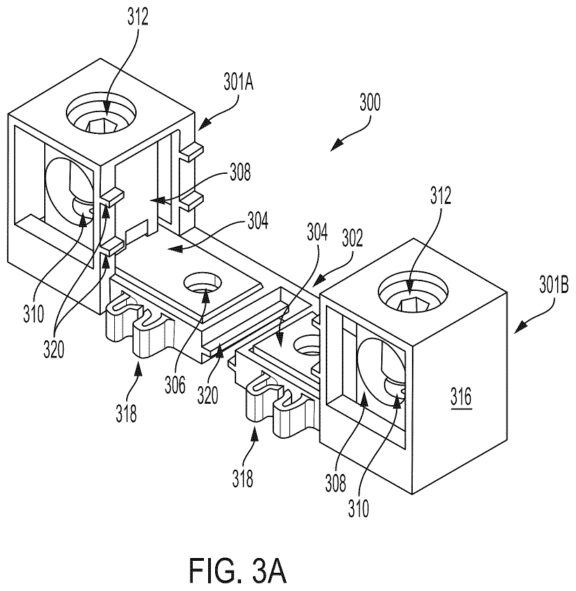

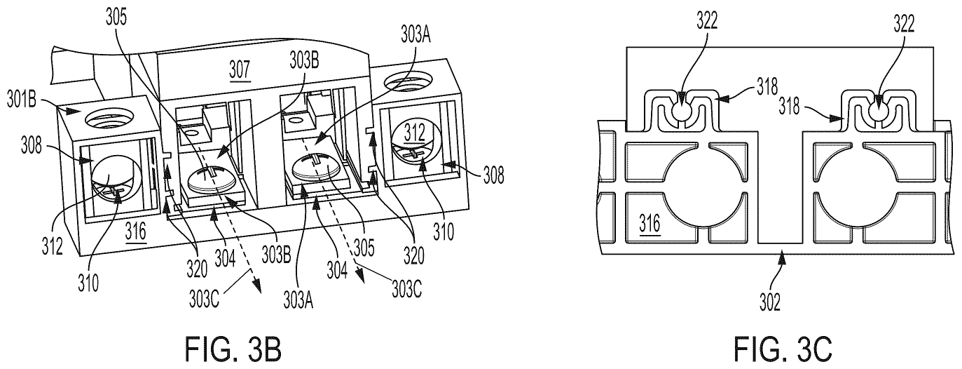

FIGS. 3A, 3B, and 3C depict a lug connection shoe 300 (e.g., terminal lug connector) that can cover and/or electrically connect to both terminals 303A, 303B (e.g., a terminal tongue) of a circuit breaker 307, which may aid in the reduction of parts relative to separate lug connection shoes for each terminal 303A, 303B. The lug connection shoe 300 can be mirror symmetrical about a center bridge 302 connecting each portion 301A and 301B. The lug connection shoe 300 can electrically connect to each terminal 303A, 303B of a circuit breaker 307 by providing a portion (e.g., 301A, 301B) for each terminal (e.g., 303A, 303B, respectively). Each portion 301A, 301B can include a terminal extension 304 (e.g., a screw plate) that can electrically couple to a terminal 303A, 303B of the circuit breaker 307 at one end (e.g., at a terminal couple point 306 configured to receive the terminal screw 305) and couple to a conductive wire cable at the other end (e.g., at lug 308 (e.g., an electrical coupling point) that terminates a received cable to the terminal extension 304). The terminal extension 304 can be affixed and/or electrically connected to the terminal 303A, 303B in different ways, including via screw 305. The terminal extension 304 can include common conductive materials (e.g., copper, brass, aluminum, alloys thereof) in order to convey electrical power between the conductive wire cable and the terminal of the circuit breaker.

An electrical coupling point (e.g., the lug 308) can be positioned atop the terminal extensions 304, and/or provide an enclosure to support the electrical connection of the conductive wire cable (e.g., the conductive wires) to the terminal extension 304. For example, the lug 308 can receive the wires of the conductive wire cable and help electrically connect (e.g., via screw type, ring type, pressure fit contacting) the wires to the terminal extension 304. The lug 308 can also include common conductive materials (e.g., copper, brass, aluminum, alloys thereof) to convey (e.g., conduct) electrical power. For lug type connections, the lug 308 can include a terminal 312 and a lug screw 310 that helps in compressing (e.g. crimping) the wire of the conductive wire cable and facilitate the electrical connection of the lug 308 to the terminal extension 304. For instance, the terminal 312 can crimp the wire, and the lug screw 310 can help affix the lug 308 to the terminal extension 304. In other words, the lug 308 can be an electrical connector that uses a wire crimp connection and/or a bolted stud hole connection. The lug connection shoe 300 can include a plastic housing 316 (e.g., typically a non-conductive plastic material) that surrounds the lug 308 and/or supports the terminal extension 304.

The housing 316 of the lug connection shoe 300 can include extensions that help the lug connection shoe to interface with (e.g., affix to) a circuit breaker 307. For example, the housing 316 can include pronged extensions 318 that can insert into a corresponding opening (e.g., a cavity) of a housing of the circuit breaker 307, providing a resistance to turning of the lug connection shoe 300 during installation and/or operation. Additionally, and/or alternatively, the pronged extensions 318 can provide a snap fit (e.g., via post 322) in the corresponding cavity of the circuit breaker 307 housing as shown in FIG. 3C. Additionally, and/or alternatively, the lug connection shoe 300 can include projecting extensions 320 that also insert into a corresponding opening (e.g., a groove) of the housing of the circuit breaker 307. The projecting extensions 320 can be slender (e.g., a greater width and length than height) to aid in the insertion into the corresponding opening. For example, the extensions (e.g., pronged extensions 318, projecting extensions 320) can be slid into the corresponding groove and/or cavity of the circuit breaker 307 housing during installation to help affix the lug connection shoe 300 to the circuit breaker 307 (e.g., via pressure fit, adhesive, snap fit to post 322). The lug connection shoe 300 can then be uninstalled by moving the lug connection shoe 300 away from the circuit breaker 307 via translational movement (e.g., sliding) and thereby provide access to the terminals 303A, 303B.

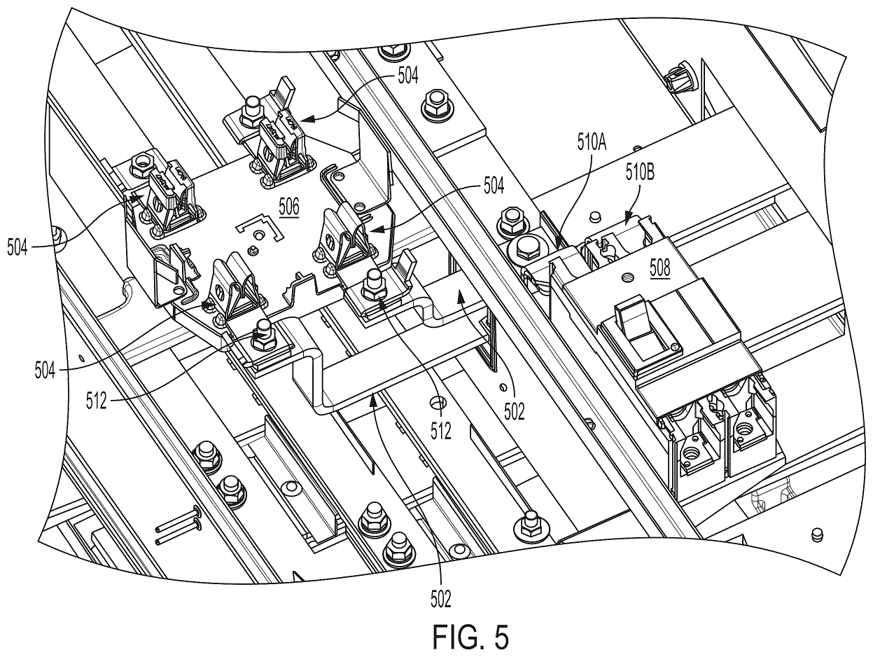

As shown in FIG. 3B, the terminal extensions 304 can be configured to provide a conductive strap between the inside of the circuit breaker 307 housing (e.g., at the terminal connection point 306) and the outside of the circuit breaker 307 housing (e.g., at the lugs 308) by extending outside and/or beyond the circuit breaker 307 housing. The terminal extensions 304 are shown extending from the terminals 303A, 303B at a ninety degree angle relative to a direction of extension 303C of the terminals 303A, 303B. However, the terminal extensions 304 (and lug connection shoe 300) can extend outside of the circuit breaker housing 307 and/or away from terminals 303A, 303B at other angles and/or more directions for different applications (e.g., as shown in FIG. 5).

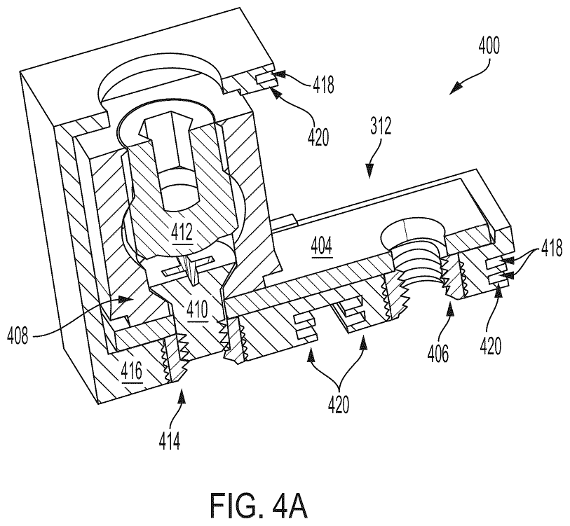

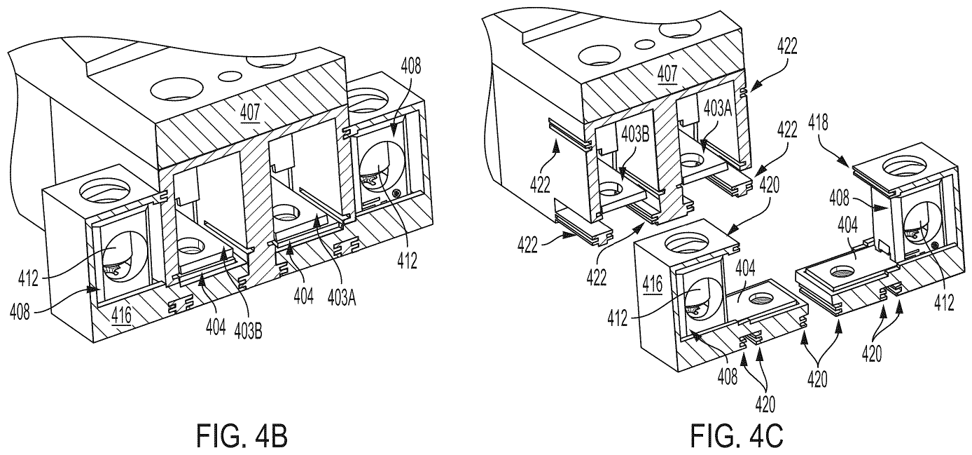

FIGS. 4A, 4B, and 4C depict a single terminal version of a lug connection shoe 400. In contrast to lug connection shoe 300, lug connection shoe 400 can cover and/or electrically connect to a single terminal, 403A or 403B, of a circuit breaker 407, which may provide greater flexibility and variability in implementation (e.g., non-symmetrical terminal extension angles, orientations, lengths). The lug connection shoes 400 can be mirror symmetrical to each other, and the lug connection shoes 400 can each electrically connect to respective terminal 403A or 403B of a circuit breaker 407. Each lug connection shoe 400 can include a terminal extension 404 (e.g., a screw plate) that can electrically couple to a terminal 403A, 403B of the circuit breaker 407 at one end (e.g., at a terminal couple nut 406 configured to receive a screw for affixing the terminal 403A, 403B to the terminal extension 404) and couple to a conductive wire cable at the other end (e.g., at lug 408 that terminates a received cable to the terminal extension 404). The terminal extension 404 can include common conductive materials (e.g., copper, brass, aluminum, alloys thereof) in order to convey electrical power between the conductive wire cable and the terminal of the circuit breaker.

The lug 408 can provide an enclosure to support the electrical connection of the conductive wire cable (e.g., the conductive wires) to the terminal extension 404. For example, the lug 408 can receive the wires of the conductive wire cable and/or help connect (e.g., via screw type, ring type, pressure fit contacting) the wires to the terminal extension 404. The lug 408 can also include common conductive materials (e.g., copper, brass, aluminum, alloys thereof) to convey (e.g., conduct) electrical power. For lug type connections, the lug 408 can include a terminal 412, threaded nut 414 (e.g., a steel insert) and/or lug screw 410 that helps in compressing the wire of the conductive wire cable and facilitate the electrical connection of the lug 408 to the terminal extension 404. In other words, the lug 408 can be an electrical connector that uses a wire crimp connection and/or a bolted stud hole connection. The lug connection shoe 400 can include a plastic housing 416 (e.g., typically a non-conductive plastic material) that surrounds the lug 408 and/or supports the terminal extension 404.

The housing 416 of the lug connection shoe 400 can include extensions that help the lug connection shoe to interface with a circuit breaker 407. For example, the lug connection shoe 400 can include projecting extensions 420 and/or extension grooves 418 that insert into a corresponding opening (e.g., a groove) and/or extensions 422 positioned at different locations of the housing of the circuit breaker 407. The projecting extensions 420 and/or extension grooves 418 can be slender (e.g., a greater width and length than height) to aid in the insertion into the corresponding opening. For example, the extensions (e.g., projecting extensions 420 and/or extension grooves 418) can be slid into the corresponding groove and/or extension 422 of the circuit breaker 407 housing during installation and/or help affix the lug connection shoe 400 to the circuit breaker 407 (e.g., via pressure fit, adhesive, snap fit). The lug connection shoe 400 can then be uninstalled by moving the lug connection shoe 400 away from the circuit breaker 407 via translational movement (e.g., sliding) and thereby provide access to the terminals 403A, 403B.

FIG. 5 depicts terminal extensions 502 provided for bolt-on connections. For example, in modular metering (e.g., for an apartment complex), metering can be used to measure the power pulled on meter hookups 504 of a meter base 506. The circuit breaker 508 can be mounted adjacent to the meter base 506 (e.g., onto a busbar) and/or within close proximity to the meter base 506. For instance, the circuit breaker 508 is shown to be mounted adjacent to the meter base 506, with an offset approximately the width of the terminal extension 502. The terminal extensions 502 (e.g., copper, brass, aluminum, alloys thereof) might not require a lug, and/or can be L-shaped. For example, terminal extensions 502 electrically couple to terminals 510A, 510B of the circuit breaker 508, extend outwards and in line with the terminals 510A, 510B, then turn ninety degrees where both extend in the same direction outside of the housing of the circuit breaker 508 towards an electrical coupling point 512 (e.g., a bolt-on connection) for a meter hookup 504. For instance, the direct bolt-on connection can allow the circuit breaker to be directly connected via terminal extensions to the meter hookup 504 without lugs and/or wires. Additionally, and/or alternatively, the terminal extensions 502 can extend in any and/or all three dimensions (x, y, z) as shown in FIG. 5, as the terminal extensions 502 extend outwards and in-line with the terminals 510A, 510B, then dip down below the terminals 510A, 510B, extend to the left towards a meter hookup 504, then extend back up to the electrical coupling point 512. The lug connection shoes 300, 400 can also utilize terminal extensions similar to terminal extensions 502. For example, terminal extensions 304, 404 can also extend in three-dimensions, extend to the same side of the housing of the circuit breaker, and/or provide bolt-on connections. Additionally, and/or alternatively, the electrical coupling point 512 can differ for the two terminal extensions 502, such that one or both terminal extensions 502 can include a lug (e.g., similar to lug 408) for receiving line and/or load wires.

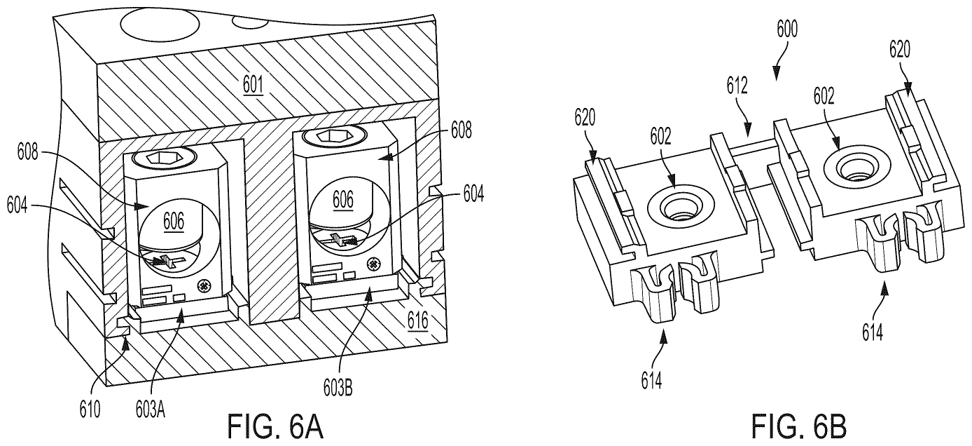

FIGS. 6A and 6B depict in-line lug connection shoes 600 (e.g., without terminal extensions). The shoes 600 can be mirror symmetrical to each along bridge 612, and configured to receive the terminals 603A, 603B of a circuit breaker 601 into a depression of the housing 616 (e.g., non-conductive plastic). The shoes 600 can also be configured to be received within the circuit breaker 601 housing. For example, the shoes 600 can include a lug 608 positioned atop the terminals 603A, 603B, with a lug screw 604 configured to affix the lug 608 to the respective terminal 603A, 603B and be received in the threaded insert 602. The lug terminal 606 can crimp a conductive wire cable to electrically couple (e.g., electrically connect) the lug 608 to the terminal 603A, 603B as described above with respect to FIGS. 3A, 3B, 3C, 4A, 4B, and/or 4C. Additionally, and/or alternatively, the housing 616 can include pronged extensions 618 and/or projecting extensions 620 (e.g., similar to pronged extensions 318 and/or projecting extensions 320). The projecting extensions 620 can interface with a corresponding groove and/or extension 610 (e.g., by translation motional such as sliding).

The lug connection shoes 600 can be used in conjunction with lug connection shoes 300, 400, and/or terminal extensions 502. For example, as shown in FIGS. 1 and/or 2, either of lug connection shoes 300 and/or 400 can be used for the terminals on one end of the circuit breaker 102 (e.g., lug connection shoes 108) and/or 202 (e.g., lug connection shoes 208), and lug connection shoes 600 can be used on the other end of the circuit breaker 102 (e.g., lug connection shoes 110) and/or 202 (e.g., lug connection shoes 210). Additionally, and/or alternatively, terminal extensions 502 can be used on the terminals 510A, 510B of the circuit breaker 508, and lug connection shoes can be used on the other terminals (e.g., on the opposite side) of the circuit breaker 508. Additionally, and/or alternatively, lug connection shoes can be used to receive conductive wire cables on the line side cables or the load side cables.

Embodiments of the present disclosure have been disclosed above with respect to circuit breakers. Embodiments of the present disclosure can also be used in conjunction with electrical contacts and electrical relays, and provide the same advantages. For example, based on accommodating the geometry of the lug connection shoes to the electrical device, embodiments of the present disclosure can be applicable to any line-load electrical device. Additionally, and/or alternatively, embodiments of the present disclosure can be useful in an enclosure mounted device in which space for wire bending is a concern. Additionally, and/or alternatively, embodiments of the present disclosure can be applicable in non-enclosure mounted applications to allow for wires to come in from the same side without any bends, thereby simplifying the installation, reducing the wire bend space, and reducing wire cost (e.g., because wires without a bend will use less length of wire than wires with a bend).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A device, comprising:
an electrical coupling point configured to receive an electrically conductive cable and convey current between the electrically conductive cable and a terminal extension; and
the terminal extension comprising a conductive structure configured to electrically couple to the electrical coupling point at a first end of the terminal extension and a terminal of a circuit breaker at a second end of the terminal extension, and extend between the first end and the second end,
wherein the terminal extension is configured to extend away from the terminal at the second end to the electrical coupling of the lug at the first end outside of a housing of the circuit breaker.

2. The device of claim 1, wherein the electrical coupling point comprises a lug, and wherein the device further comprises:
a housing comprising a first portion and a second portion, wherein the first portion partially surrounds the lug and the second portion partially surrounds the terminal extension, and wherein the first portion comprises an opening for receiving the electrically conductive cable in the lug.

3. The device of claim 2, wherein the housing comprises extensions configured to interface with corresponding grooves of the housing of the circuit breaker.

4. The device of claim 3, wherein the extensions comprise a length greater than their height, the extensions configured to interface with the corresponding grooves by sliding along a single plane into the corresponding grooves.

5. The device of claim 1, wherein the terminal extension is configured to extend perpendicularly to an axis of extension of the terminal.

6. The device of claim 1, wherein the terminal extension is configured to electrically couple to the terminal when positioned between the terminal and a surface affixed to the circuit breaker.

7. The device of claim 1, wherein the terminal extension extends away from an axis of extension of the terminal.

8. The device of claim 1, wherein the electrically conductive cable is a load side cable configured to travel a path around the circuit breaker to the terminal extension, and wherein the terminal extension further extends to a point on the path of the electrically conductive cable.

9. The device of claim 1, wherein the electrically conductive cable is a line side cable configured to travel a path around the circuit breaker to the terminal extension, and wherein the terminal extension further extends to a point on the path of the electrically conductive cable.

10. The device of claim 1, further comprising:
a second electrical coupling point configured to receive a second electrically conductive cable and convey current between the second electrically conductive cable and a second terminal extension;
the second terminal extension comprising a second conductive structure configured to extend from the second electrical coupling point to a second terminal of the circuit breaker, wherein an axis of extension of the second terminal is parallel to the axis of extension of the first terminal; and
a housing comprising a first portion partially surrounding the electrical coupling point, a second portion partially surrounding the second electrical coupling point, and a third portion partially surrounding the terminal extension and the second terminal extension,
wherein the second terminal extension is configured to extend away from the axis of extension of the second terminal in the opposite direction of the terminal extension.

11. A system, comprising:
an electrically conductive cable;
a circuit breaker, comprising:
a terminal configured to electrically couple to a terminal extension; and
a housing partially surrounding the terminal, and
a terminal connecter, comprising:
an electrical coupling point configured to receive an electrically conductive cable and convey current between the electrically conductive cable and the terminal extension; and
the terminal extension comprising a conductive structure configured to electrically couple to the electrical coupling point at a first end of the terminal extension and the terminal of the circuit breaker at a second end of the terminal extension, and extend between the first end and the second end,
wherein the terminal extension is configured to extend away from the terminal at the second end to the electrical coupling of the lug at the first end outside of a housing of the circuit breaker.

12. The system of claim 11, wherein the electrical coupling point comprises a lug, and wherein the terminal connector further comprises:
a housing comprising a first portion and a second portion, wherein the first portion partially surrounds the lug and the second portion partially surrounds the terminal extension, and wherein the first portion comprises an opening for receiving the electrically conductive cable in the lug.

13. The system of claim 12, wherein the housing comprises extensions configured to interface with corresponding grooves of the housing of the circuit breaker.

14. The system of claim 13, wherein the extensions comprise a length greater than their height, the extensions configured to interface with the corresponding grooves by sliding along a single plane into the corresponding grooves.

15. The system of claim 11, wherein the terminal extension is configured to extend perpendicularly to an axis of extension of the terminal.

16. The system of claim 11, wherein the terminal extension is configured to electrically couple to the terminal when positioned between the terminal and a surface affixed to the circuit breaker.

17. The system of claim 11, wherein the terminal extension extends away from an axis of extension of the terminal.

18. The system of claim 11, wherein the electrically conductive cable is a load side cable configured to travel a path around the circuit breaker to the terminal extension, and wherein the terminal extension further extends to a point on the path of the electrically conductive cable.

19. The system of claim 11, wherein the electrically conductive cable is a line side cable configured to travel a path around the circuit breaker to the terminal extension, and wherein the terminal extension further extends to a point on the path of the electrically conductive cable.

20. The system of claim 11, wherein the housing of the circuit breaker comprises an open side for receiving an electrically coupling for the terminal and a closed side on each side adjacent to the open side, and wherein the terminal extension is further configured to extend from the terminal at the second end, across a closed side, and to the electrical coupling point at the first end.
